(19) United States
(12) Patent Application Publication
(10) Pub. No.: US 2025/0151699 A1
(43) Pub. Date: May 15, 2025

(54) PET TOYS

(71) Applicant: Worldwise, Inc., Novato, CA (US)

(72) Inventors: Aimee Diskin, Napa, CA (US); Hannah Rosenberg, San Francisco, CA (US); Cristen Underwood, Westminster, CO (US); Daniel Lee, Emeryville, CA (US)

(21) Appl. No.: 18/946,823

(22) Filed: Nov. 13, 2024

Related U.S. Application Data
(60) Provisional application No. 63/598,318, filed on Nov. 13, 2023.

(51) Int. Cl. A01K 15/02; A01K 5/01

(52) U.S. Cl. CPC A01K 15/025; A01K 5/0114

(57) ABSTRACT

A pet toy has a first portion and a second portion. The first portion includes an interior cavity and a sound mechanism. The second portion is removably connected to the first portion and the second portion includes a food cavity with a food opening. The food opening is closed when the first portion and the second portion are connected to each other. The food opening is open when the first portion and the second portion are disconnected from each other.

### CROSS-REFERENCE TO RELATED APPLICATIONS

The present application claims the benefit of U.S. Provisional Application Ser. No. 63/598,318, filed on Nov. 13, 2023, entitled PET TOYS (Attorney Docket No. 40472.04443), the entire disclosure of which is incorporated herein by reference in its entirety.

### TECHNICAL FIELD

The present application relates generally to pet toys and in particular to pet toys that include a sound mechanism that makes a noise during play and a treat cavity that can release a treat when opened during play.

### BACKGROUND

Dogs (and other pets) benefit from playing with toys that encourage interaction, are entertaining, and that are durable to withstand the kind of tough play in which dogs engage.

### SUMMARY

Exemplary embodiments of pet toys and methods of using the same are disclosed herein.

An example of a pet toy described herein includes a first portion and a second portion. The first portion includes an interior cavity and a sound mechanism. The second portion is removably connected to the first portion and the second portion includes a food cavity with a food opening. The food opening is closed when the first portion and the second portion are connected to each other. The food opening is open when the first portion and the second portion are disconnected from each other.

An example of a method of using a pet toy described herein includes steps of: providing a pet toy having a first portion and a second portion, the first portion including an interior cavity and a sound mechanism, the second portion including a food cavity and a food opening; placing a treat in the food cavity; connecting the second portion to the first portion; and closing the food opening of the food cavity. The food opening is closed when the first portion and the second portion are connected to each other. And the food opening is open when the first portion and the second portion are disconnected from each other.

A further understanding of the nature and advantages of the present invention are set forth in the following description and claims, particularly when considered in conjunction with the accompanying drawings in which like parts bear like reference numerals.

### BRIEF DESCRIPTION OF THE DRAWINGS

To further clarify various aspects of embodiments of the present disclosure, a more particular description of the certain embodiments will be made by reference to various aspects of the appended drawings. It is appreciated that these drawings depict only typical embodiments of the present disclosure and are therefore not to be considered limiting of the scope of the disclosure. Moreover, while the figures can be drawn to scale for some embodiments, the figures are not necessarily drawn to scale for all embodiments. Embodiments and other features and advantages of the present disclosure will be described and explained with additional specificity and detail through the use of the accompanying drawings in which:

FIG. 1 is a perspective view of an example pet toy, showing a first portion and a second portion in a connected configuration;

FIG. 2 is a perspective view of the pet toy of FIG. 1, showing the first and second portions in a disconnected configuration;

FIG. 3 is an exploded view of the pet toy of FIG. 1;

FIG. 4 is a front view of an example squeaker mechanism for the pet toy of FIG. 1;

FIG. 5 is a perspective view of the squeaker mechanism of FIG. 4;

FIG. 6 is a top view of the pet toy of FIG. 1;

FIG. 7 is a front view of the pet toy of FIG. 1;

FIG. 8 is a perspective view of another example pet toy;

FIG. 9 is a top view of the pet toy of FIG. 8;

FIG. 10 illustrates movement of an example treat portion of the pet toy of FIG. 8 relative to an example main body of the pet toy;

FIG. 11 is an exploded view of the pet toy of FIG. 8;

FIG. 12 is a front view of the main body of the pet toy of FIG. 8;

FIG. 13 is a top view of the main body of FIG. 12;

FIG. 14 is a front view of the treat portion of the pet toy of FIG. 8; and

FIG. 15 is a side view of the treat portion of FIG. 14.

### DETAILED DESCRIPTION

The following description refers to the accompanying drawings, which illustrate specific embodiments of the present disclosure. Other embodiments having different structures and operation do not depart from the scope of the present disclosure.

In the following description, for purposes of explanation, numerous specific details are set forth in order to provide a thorough understanding of one or more aspects. It may be evident, however, that such aspect(s) may be practiced without these specific details. In other instances, well-known structures and devices are shown in block diagram form in order to facilitate describing one or more aspects. Further, it is to be understood that functionality that is described as being carried out by certain system components may be performed by multiple components. Similarly, for instance, a component may be configured to perform functionality that is described as being carried out by multiple components.

As described herein, when one or more components are described as being connected, joined, affixed, coupled, attached, or otherwise interconnected, such interconnection may be direct as between the components or may be indirect such as through the use of one or more intermediary components. Also as described herein, reference to a “member,” “component,” or “portion” shall not be limited to a single structural member, component, or element but can include an assembly of components, members, or elements. Additionally, as used herein, the term “exemplary” is intended to mean serving as an illustration or example of something and is not intended to indicate a preference.

Moreover, the term “or” is intended to mean an inclusive “or” rather than an exclusive “or.” That is, unless specified otherwise, or clear from the context, the phrase “X employs A or B” is intended to mean any of the natural inclusive permutations. That is, the phrase “X employs A or B” is satisfied by any of the following instances: X employs A; X employs B; and X employs both A and B. In addition, the articles “a” and “an” as used in this application and the appended claims should generally be construed to mean “one or more” unless specified otherwise or clear from the context to be directed to a singular form.

Numerical values or ranges stated herein are understood to encompass values at or near the stated value and/or above or below the stated range. For this application, the stated value can encompass plus or minus 5% of the value and the stated range can encompass plus or minus 5% of the extent of the range. In addition, the stated value or range can include a margin of error for the value or range typical in the art for the property being measured. The stated value or range can also encompass those values and ranges that would be considered equivalent to the stated value or range by one of ordinary skill in the art. As an example, a distance expressed as a range of 2 inches to 12 inches is understood to include durations above and below the ends of the range by 5% of the extent of the 10 inch range—e.g., 1.5 inches to 12.5 inches. As another example, the size of an object expressed as a value of 5 inches includes values above and below 5 inches that are within the margin of error of a tool typically used to measure objects of that size. As yet another example, an angle between two components expressed as a value of 20 degrees includes values above and below 20 degrees that would be considered equivalent by one of ordinary skill in the art.

The pet toys described herein have a first portion and a second portion that are removably connected to each other such that a pet can engage the pet toys and disconnect the first and second portions from each other during play. The first portion can have a sound mechanism (e.g., a squeaker) that is configured to generate a sound (e.g., a squeaking sound) during play. The second portion can have a food or treat cavity that is configured to hold pet food, where the food cavity is closed such that the pet cannot access the food when the first and second portions are connected to each other, and where the food cavity is open such that the pet can access the food when the first and second portions are disconnected from each other.

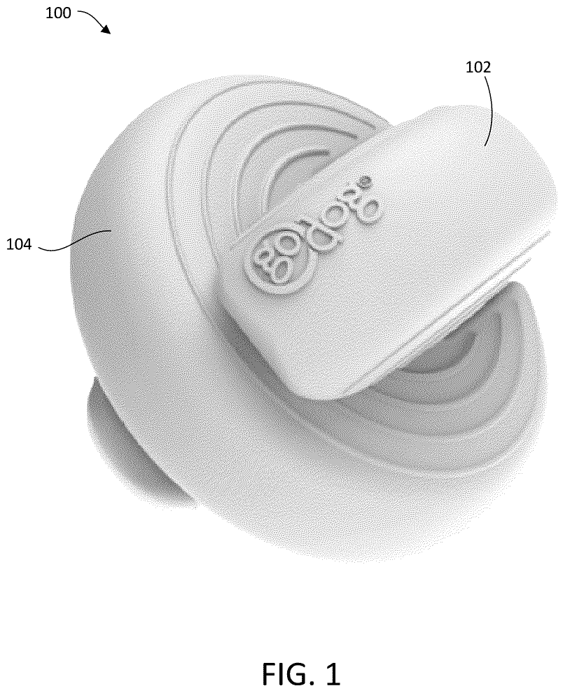

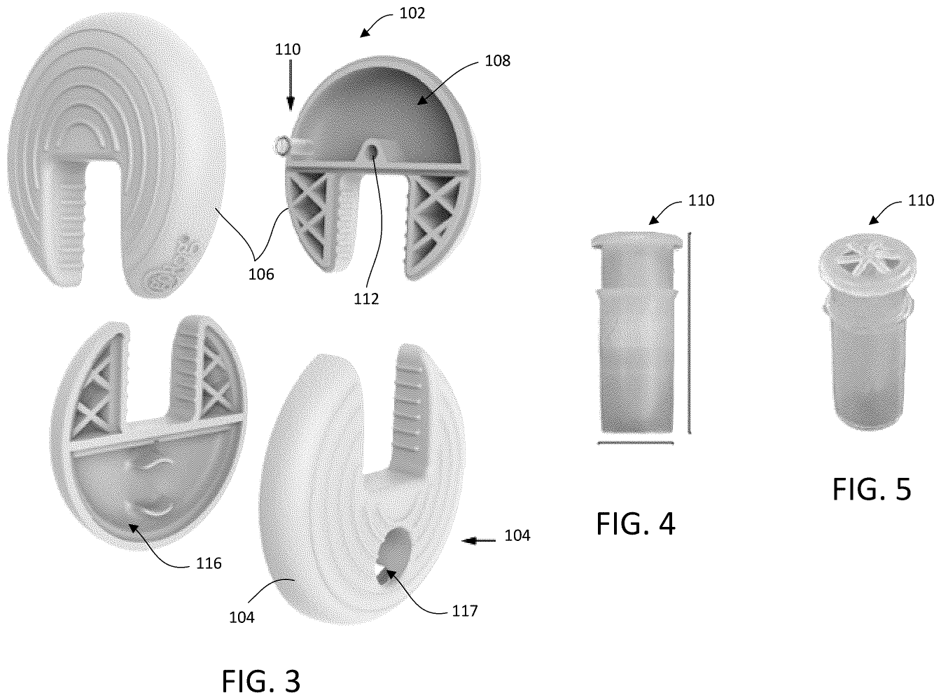

FIGS. 1-7 illustrate an example pet toy 100 that includes a first portion 102 and a second portion 104. The first portion 102 includes a housing 106 that defines an interior cavity 108 (FIG. 3) and a sound mechanism 110 (FIGS. 3-5). The housing 106 can be made of any suitable material that is durable such that a pet is inhibited from fracturing the housing 106 during play. For example, the housing 106 can be made of thermoplastic rubber (TPR). However, it should be understood that the housing 106 can be made of any other suitable material that is capable of inhibiting a pet from fracturing the housing 106. The housing 106 is configured to receive the sound mechanism 110 such that the sound mechanism 110 is disposed within or proximate the interior cavity 108, and such that when a pet engages the housing 106 proximate the interior cavity 108, the sound mechanism 110 generates a sound. In the illustrated example, the housing 106 has an opening 112 (FIG. 3) for receiving the sound mechanism 110. The sound mechanism 110 can take any suitable form, such as, for example, the form of any suitable squeaker mechanism or any other mechanism that is capable of generating a sound when the housing 106 and cavity 108 are engaged by a pet.

The interior cavity 108 can be sized such that the pet can engage a substantial portion of the surface area of the housing 106 to cause the sound mechanism 100 to generate a sound. In some examples, the interior cavity 108 can be sized and shaped such that the interior cavity 108 can assist the sound mechanism 110 in generating the sound. For example, the sound mechanism 110 can be a squeaker mechanism that does not include a bulb or air pocket that assists in creating a squeaking sound, and the interior cavity 108 can act as the bulb or air pocket that is used to create the squeaking sound.

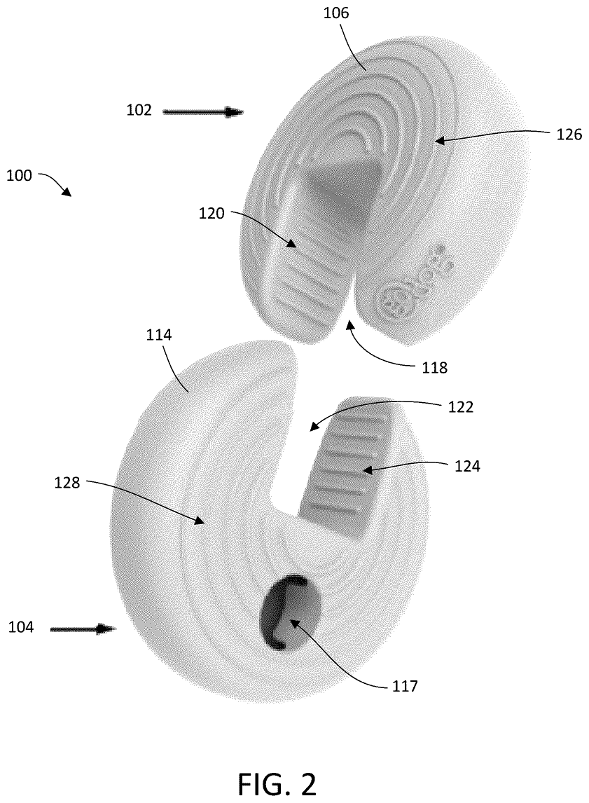

The second portion 104 includes a housing 114 that defines a food cavity 116 (FIG. 3) and a food opening 117 (FIGS. 2-3) that allows a pet to access the food cavity 116. The housing 114 can be made of any suitable material that is durable such that a pet is inhibited from fracturing the housing 114 during play. For example, the housing 114 can be made of thermoplastic rubber (TPR). However, it should be understood that the housing 114 can be made of any other suitable material that is capable of inhibiting a pet from fracturing the housing 114.

Referring to FIG. 2, the first portion 102 can include a first connection channel 118 that is defined by the housing 106. The first connection channel 118 can include one or more ribs 120. The second portion 104 can include a second connection channel 122 that is defined by the housing 114. The second connection channel 122 can include one or more ribs 124. The first portion 102 and the second portion 104 are configured to removably attached to each other by an interlocking connection (as shown in FIG. 1). For example, the first connection channel 118 of the first portion 102 is configured to interlock with the second connection channel 122 of the second portion 104. In some examples, the housing 106 of the first portion 102 includes one or more exterior ribs 126, and the one or more ribs 124 of the channel 122 of the second portion 104 are configured to engage the exterior ribs 126 of the first portion 102 to attach the second portion 104 to the first portion 102. Similarly, the housing 114 of the second portion 104 includes one or more exterior ribs 128, and the one or more ribs 120 of the channel 118 of the first portion 102 are configured to engage the exterior ribs 128 of the second portion 104 to attach the first portion 102 to the second portion 104. However, it should be understood that the first and second portions 102, 104 can be removably connected to each other by any other suitable means.

Referring to FIG. 1, when the first and second portions 102, 104 are connected to each other, the housing 106 of the first portion 102 covers the food opening 117 (FIGS. 2-3) of the second portion 104 such that food or treats are maintained within the food cavity 116 (FIG. 3) and a pet cannot access such food or treats. Referring to FIG. 2, when the first and second portions 102, 104 are disconnected from each other, the food opening 117 is uncovered such that a pet can access the food or treats within the food cavity 116.

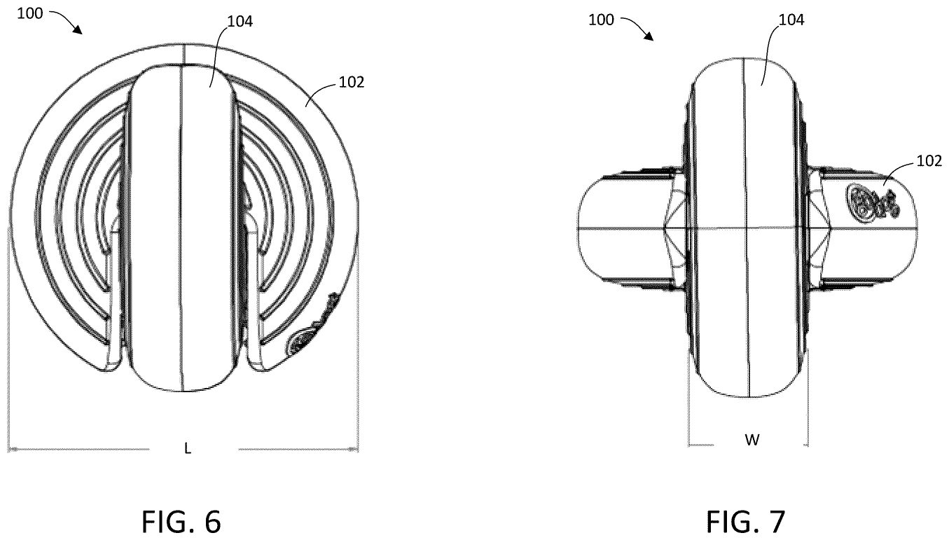

The first and second portions 102, 104 can be sized and shaped to facilitate movement of the pet toy 100 during play. In the illustrated example, the first and second portions 102, 104 have substantially the same shape. Referring to FIG. 6, the first portion 102 can have a length L that is between about 50 mm and about 150 mm, such as about 100 mm. It should be understood that the second portion 104 can have the same length L or a different length L. Referring to FIG. 7, the second portion 104 can have a width of between about 15 mm and about 55 mm, such as about 36.5 mm. It should be understood that the first portion 102 can have the same width W or a different width W. The first and second portions 102, 104 are shown as having a rounded shape, but it should be understood that the first and second portions 102, 104 can have any other suitable shape. It should also be understood that the first and second portions 102, 104 can have different shapes relative to each other.

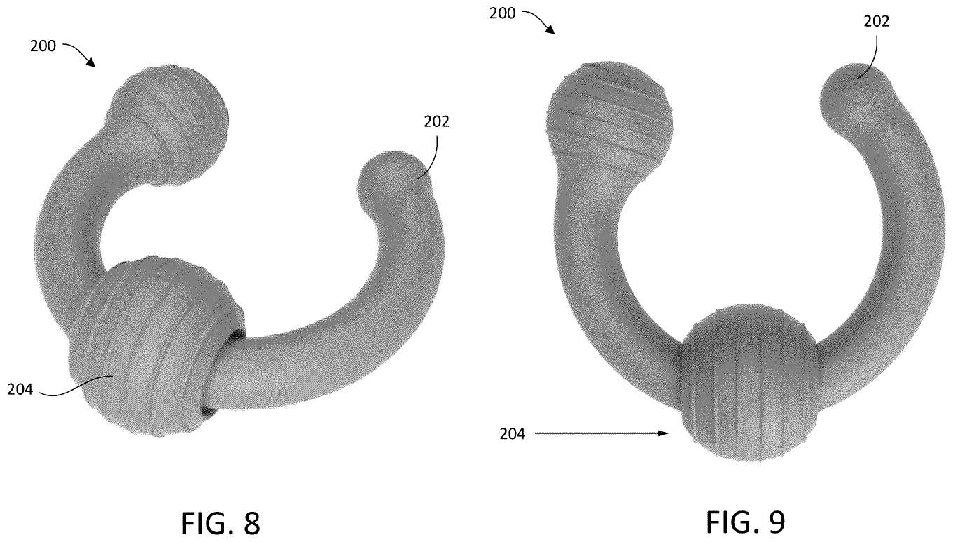

FIGS. 8-15 illustrate another example pet toy 200 that includes a first portion 202 and a second portion 204. The first portion 202 includes a housing 206 that defines an interior cavity 208 (FIG. 11) and a sound mechanism 210 (FIG. 11). The housing 206 can be made of any suitable material that is durable such that a pet is inhibited from fracturing the housing 206 during play. For example, the housing 206 can be made of thermoplastic rubber (TPR). However, it should be understood that the housing 206 can be made of any other suitable material that is capable of inhibiting a pet from fracturing the housing 206.

The housing 206 is configured to receive the sound mechanism 210 such that the sound mechanism 210 is disposed within or proximate the interior cavity 208, and such that when a pet engages the housing 206 proximate the interior cavity 208, the sound mechanism 210 generates a sound. In the illustrated example, the housing 206 has an opening 212 (FIG. 11) for receiving the sound mechanism 210. The sound mechanism 210 can take any suitable form, such as, for example, the form of any suitable squeaker mechanism or any other mechanism that is capable of generating a sound when the housing 206 and cavity 208 are engaged by a pet.

The interior cavity 208 can be sized such that the pet can engage the housing 206 to cause the sound mechanism 210 to generate a sound. In some examples, the interior cavity 208 can be sized and shaped such that the interior cavity 208 can assist the sound mechanism 210 in generating the sound. For example, the sound mechanism 210 can be a squeaker mechanism that does not include a bulb or air pocket that assists in creating a squeaking sound, and the interior cavity 208 can act as the bulb or air pocket that is used to create the squeaking sound. In the illustrated example, the interior cavity 208 is positioned proximate a first end 232 of the housing 206. However, it should be understood that the interior cavity 208 can be positioned at any other suitable location of the housing 206.

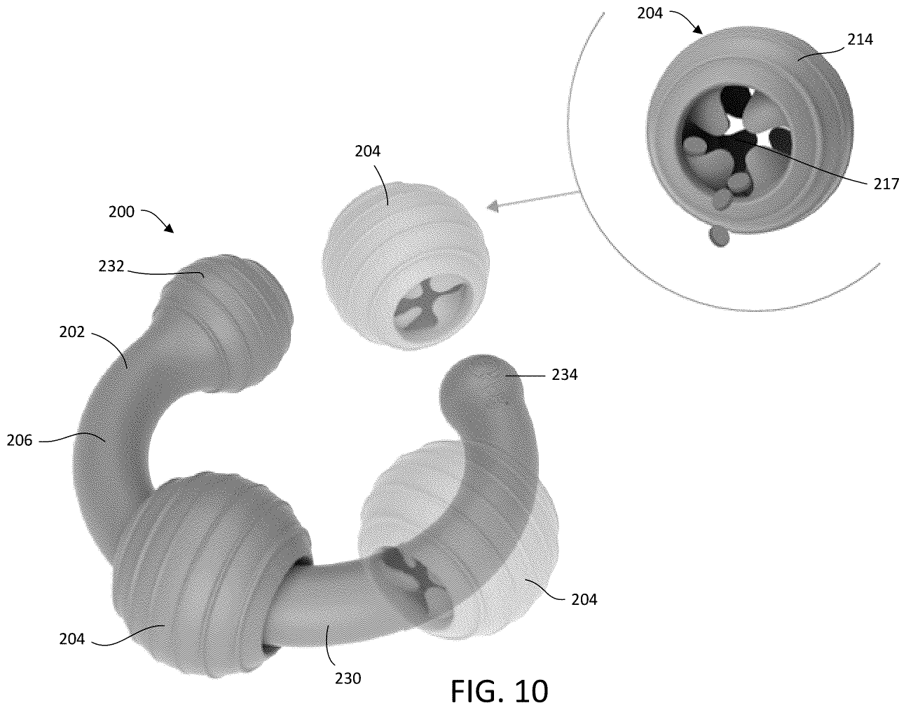

The second portion 204 includes a housing 214 that defines a food cavity 216 (FIG. 11) and one or more food openings 217 (FIGS. 10-11) that allows a pet to access the food cavity 216. The housing 214 can be made of any suitable material that is durable such that a pet is inhibited from fracturing the housing 2114 during play. For example, the housing 214 can be made of thermoplastic rubber (TPR). However, it should be understood that the housing 214 can be made of any other suitable material that is capable of inhibiting a pet from fracturing the housing 214.

Referring to FIG. 10, the first and second portions 202, 204 can be slidably connected such that the second portion 204 is capable of sliding relative to the first portion 202. For example, the housing 206 of the first portion 202 can extend through the openings 217 and the food cavity 216 of the second portion 204 such that the second portion 204 is capable of sliding relative to the housing 206 of the first portion 202. The housing 206 can have a main body 230, a first end 232, and a second end 234. The main body 230 can be sized and shaped such that the first portion 204 can slide relative to the main body 230. The interior cavity 208 can be positioned proximate the first end 232 and be sized larger than the openings 217 of the second portion 204 such that the second portion 204 is prevented from being disconnected from the first portion 202 at the first end 232. The second end 234 can be sized larger than the main body 230 such that the second portion is inhibited from sliding over the second end 234, but the second end can be sized such that a pet can remove the second portion 204 from the first portion 202 over the second end by providing a force to the second portion 204 that is sufficient to disconnect the second portion 204 from the first portion 202. However, it should be understood that the first and second portions 202, 204 can be connected in any other suitable way that allows for the second portion 204 to be slidable relative to the first portion 202, as well as allow for the second portion 204 to be removably connected to the first portion 202.

Referring to FIGS. 8-10, when the first and second portions 202, 204 are connected to each other, the housing 206 of the first portion 202 extends through the food cavity 216 to maintain food or treats within the food cavity 216 and prevent the food or treats from moving through the food opening 217 such that a pet cannot access such food or treats. Referring to FIG. 10, when the first and second portions 202, 204 are disconnected from each other, the food opening 217 is uncovered such that a pet can access the food or treats within the food cavity 216.

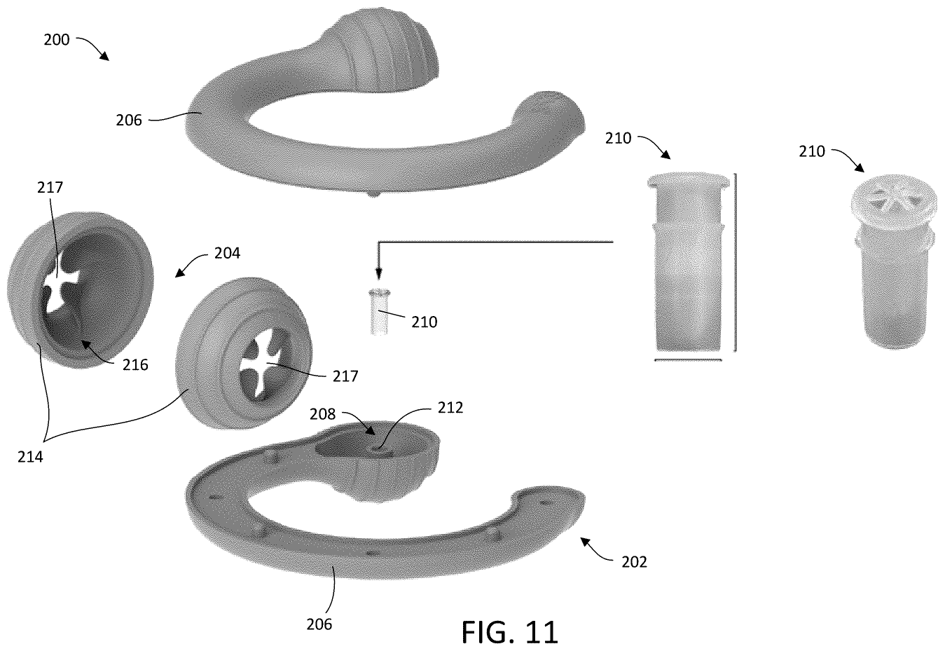

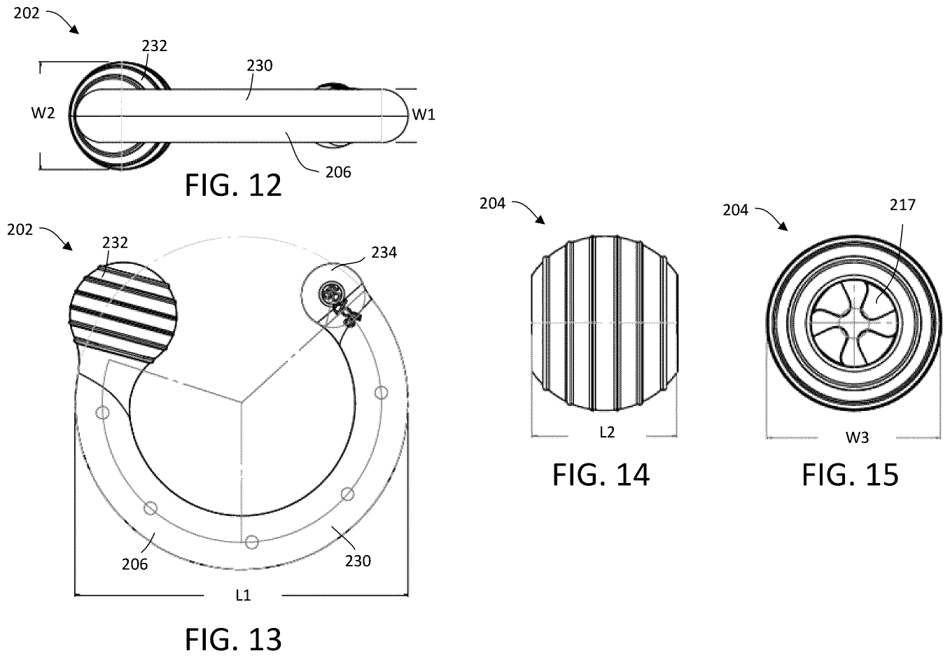

The first and second portions 202, 204 can be sized and shaped to facilitate movement of the pet toy 100 during play. Referring to FIG. 13, the first portion 202 can have a length L1 of between about 100 mm and about 200 mm, such as about 159 mm. Referring to FIG. 12, the main body 230 of the first portion 202 can have a width W1 of between about 15 mm and about 35 mm, such as about 25. 4 mm, and the first end 232 of the first portion 202 can have a width W2 of between about 25 mm and about 75 mm, such as about 51.5 mm. Referring to FIG. 14, the second portion 204 can have a length L2 of between about 25 mm and about 75 mm, such as about 52.8 mm. Referring to FIG. 15, the second portion 204 can have a width W3 of between about 40 mm and about 80 mm, such as about 63.3 mm. It should also be understood, however that the first and second portions 202, 204 can have different shapes and/or be different sizes.

While various inventive aspects, concepts and features of the inventions may be described and illustrated herein as embodied in combination with exemplary embodiments, these various aspects, concepts and features may be used in many alternative embodiments, either individually or in various combinations and sub-combinations thereof. Unless expressly excluded herein, all such combinations and sub-combinations are intended to be within the scope of the present inventions. Still further, while various alternative embodiments as to the various aspects, concepts and features of the inventions—such as alternative materials, structures, configurations, methods, devices and components, alternatives as to form, fit and function, and so on—may be described herein, such descriptions are not intended to be a complete or exhaustive list of available alternative embodiments, whether presently known or later developed. Those skilled in the art may readily adopt one or more of the inventive aspects, concepts or features into additional embodiments and uses within the scope of the present inventions even if such embodiments are not expressly disclosed herein.

Additionally, even though some features, concepts or aspects of the inventions may be described herein as being a preferred arrangement or method, such description is not intended to suggest that such feature is required or necessary unless expressly so stated. Still further, exemplary or representative values and ranges may be included to assist in understanding the present disclosure; however, such values and ranges are not to be construed in a limiting sense and are intended to be critical values or ranges only if so expressly stated. Moreover, while various aspects, features and concepts may be expressly identified herein as being inventive or forming part of an invention, such identification is not intended to be exclusive, but rather there may be inventive aspects, concepts and features that are fully described herein without being expressly identified as such or as part of a specific invention. Descriptions of exemplary methods or processes are not limited to inclusion of all steps as being required in all cases, nor is the order that the steps are presented to be construed as required or necessary unless expressly so stated.

What is claimed:

1. A pet toy comprising:
a first portion, wherein the first portion comprises an interior cavity and a sound mechanism; and
a second portion that is removably connected to the first portion, wherein the second portion comprises a food cavity and a food opening;
wherein the food opening is closed when the first portion and the second portion are connected to each other; and
wherein the food opening is open when the first portion and the second portion are disconnected from each other.

2. The pet toy of claim 1, wherein the first portion and the second portion are connected by an interlocking connection.

3. The pet toy of claim 2, wherein the first portion includes a first channel that forms the interlocking connection with a second channel of the second portion.

4. The pet toy of claim 3, wherein a width of the first portion is not greater than a width of the second channel, and a width of the second portion is not greater than width of the first channel.

5. The pet toy of claim 3, wherein a width of the first channel is equal to a width of the second channel.

6. The pet toy of claim 3, wherein at least one of the first channel and the second channel comprise internal ribs.

7. The pet toy of claim 3, wherein at least one of the first portion and the second portion comprise external ribs.

8. The pet toy of claim 1, wherein the first portion and the second portion have an identical shape.

9. The pet toy of claim 2, wherein the food opening of the second portion is covered by the first portion when the first portion and the second portion are connected to each other.

10. The pet toy of claim 1, wherein the second portion is slidably connected to the first portion.

11. The pet toy of claim 10, wherein the food opening of the second portion is covered by the first portion when the first portion and the second portion are connected to each other.

12. The pet toy of claim 10, wherein the second portion comprises two food openings.

13. The pet toy of claim 12, wherein each of the two food openings is covered by the first portion when the first portion and the second portion are connected to each other.

14. The pet toy of claim 10, wherein the first portion comprises a main body extending between a first end and a second end, and the second portion is slidably connected to the main body and can slide between the first end and the second end.

15. The pet toy of claim 14, wherein the interior cavity and the sound mechanism of the first portion are disposed in the first end of the first portion.

16. The pet toy of claim 14, wherein the main body has a U shape.

17. A method of using a pet toy, the method comprising:
providing a pet toy comprising a first portion and a second portion, wherein:
the first portion comprises an interior cavity and a sound mechanism;
the second portion comprises a food cavity and a food opening;
the food opening is closed when the first portion and the second portion are connected to each other; and
the food opening is open when the first portion and the second portion are disconnected from each other;
placing a treat in the food cavity;
connecting the second portion to the first portion; and
closing the food opening of the food cavity.

18. The method of claim 17, wherein the steps of connecting of the second portion to the first portion and closing the food opening of the food cavity are performed simultaneously.

19. The method of claim 17, wherein the second portion comprises two food openings and the step of closing the food opening of the food cavity further comprises:
closing the first food opening; and
closing the second food opening.

20. The method of claim 17, wherein the steps of closing the first food opening and closing the second food opening are performed simultaneously.
